(19) United States
(12) Patent Application Publication
(10) Pub. No.: US 2024/0362071 A1
(43) Pub. Date: Oct. 31, 2024

(54) CLOUD-BASED SYSTEMS AND METHODS FOR EXECUTION OF PYTHON SCRIPTS

(71) Applicant: Intergraph Corporation, Madison, AL (US)

(72) Inventor: Julio P. Roque, Coconut Grove, FL (US)

(21) Appl. No.: 18/141,455

(22) Filed: Apr. 30, 2023

(51) Int. Cl. G06F 9/50; G06F 9/54

(52) U.S. Cl. CPC G06F 9/5038; G06F 9/541

(57) ABSTRACT

Various embodiments of the present disclosure provide methods, apparatuses, systems, computing devices, computing entities, and/or the like for developing, managing, and executing Python scripts in a containerized, cloud-based (e.g., serverless) multi-tenant manner. Certain embodiments include a Python Studio allowing users to develop and manage scripts and/or a Flex Python system allowing execution of scripts.

### CROSS-REFERENCE TO RELATED APPLICATION(S)

None.

### BACKGROUND

The Python language is one of the most accessible programming languages available because it has simplified syntax and is not complicated, which provides more emphasis on natural language.

### BRIEF SUMMARY

Certain embodiments relate to execution of Python scripts in a containerized, cloud-based, multi-tenant manner, specifically by executing a primary service node and at least one worker service node in a cloud computing system, where the primary service node includes a pod generator and a scheduler and each worker service node executes a Python service instance comprising a Python service application program interface (API), a request validator, and a response controller. Each Python service instance is configured to receive a Python script execution request from a client via the Python service API, validate the request by the request validator, communicate the request to the primary service node, receive an output from execution of the Python script by the response controller, and asynchronously communicate the output to the client by the response controller. The primary service node is configured to generate a pod containing an application container for the Python script and assign the pod to an application worker node for execution including, when there is no existing application worker node for the pod, dynamically allocating a new application worker node and assigning the pod to the new application worker node.

In various alternative embodiments, the Python service API may be a Representational State Transfer (REST) API. The Python script execution request may include a timeout value, in which case the application worker node executing the Python script may terminate execution of the Python script if execution is not completed within the timeout value. The Python script execution request may include parameters for retrieval of the Python script (e.g., a URL or file name), in which case the application container or other appropriate component (e.g., the primary service node or a Python service instance) may retrieve the Python script based on the parameters.

Additional embodiments may be disclosed and claimed.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 is a schematic diagram of an example architecture for Python Studio in accordance with certain embodiments.

FIG. 2 is a schematic diagram showing a Python Studio home screen in accordance with certain embodiments.

FIG. 3 is a schematic diagram showing a Python Studio screen through which the user can develop the script section-by-section, thereby facilitating the development of the script.

FIG. 4 provides an exemplary overview of a system architecture that can be used to practice embodiments of the present disclosure in accordance with some embodiments discussed herein.

FIG. 5 provides an example cloud computing server computing entity, in accordance with some embodiments discussed herein in accordance with some embodiments discussed herein.

FIG. 6 provides an example client computing entity, in accordance with some embodiments discussed herein in accordance with some embodiments discussed herein.

FIG. 7 is a schematic block diagram of a cloud computing server computing entity, in accordance with some embodiments discussed herein.

FIG. 8 is a schematic block diagram of a cloud computing server computing entity operating request management and container management engines across multiple availability zones, in accordance with some embodiments discussed herein.

FIG. 9 is a schematic diagram showing details of a cloud-based multi-domain solver system 101 in accordance with various embodiments.

FIG. 10 is a schematic diagram showing details of the REST API in accordance with the embodiment of FIG. 9.

FIG. 11 is a schematic diagram showing the three primitives for the REST API in accordance with certain embodiments.

FIG. 12 schematically shows the progression of a script execution transaction in accordance with certain embodiments.

FIG. 13 schematically shows additional details of the progression of a script execution transaction in accordance with certain embodiments.

It should be noted that the foregoing figures and the elements depicted therein are not necessarily drawn to consistent scale or to any scale. Unless the context otherwise suggests, like elements are indicated by like numerals. The drawings are primarily for illustrative purposes and are not intended to limit the scope of the inventive subject matter described herein.

### DESCRIPTION OF ILLUSTRATIVE EMBODIMENTS

Various embodiments of the present disclosure are described more fully hereinafter with reference to the accompanying drawings, in which some, but not all embodiments of the disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. As used herein, the terms “data entity” and “data construct” may be used interchangeably.

### I. General Overview and Technical Advantages

Various embodiments of the present disclosure are generally directed to a Python (PYN) development, management, and execution system architecture or framework in which Python script development and Python execution occurs in a containerized, cloud-based (e.g., serverless) multi-tenant manner. Among other things, multitenancy enables software vendors to serve many customers with the same infrastructure in a highly-scalable manner, which results in lower costs and better resource utilization. In addition, multitenancy enables software providers to release new features and updates more quickly since they only need to deploy changes to a single application instance. For convenience, the script execution system may be referred to herein as Flex Python. Certain embodiments additionally or alternatively include a Python script development system that allows users to write and publish Python scripts for execution. For convenience, the script development system may be referred to herein as Python Studio. As discussed further below, certain components of Flex Python and/or Python Studio may be integrated with a host system such as, for example, an Enterprise Asset Management (EAM) system such as the Infor™ Enterprise Asset Management (EAM) system from Intergraph Corporation and formerly from Infor (US), LLC, although it should be noted that embodiments can be configured for more general use across a variety of systems. In certain embodiments, scripts can be user-initiated, event triggered (e.g., through FlexSQL configuration), and/or integrated with an alerts module (e.g., EAM Alerts).

Specifically, in various embodiments, Flex Python is based at least in part on execution of one or more container instances of one or more compute containers each corresponding to a Python script. The container instances are executed within a cloud-based multi-domain system in a serverless manner. That is, computing and processing resources may be recruited for execution of container instances on an on-demand and asynchronous basis. Accordingly, various embodiments of the present disclosure provide technical advantages by enabling flexible and elastic execution of Python scripts. In various example instances, computing and processing resources may be diverted, allocated, reserved, and/or the like for particular scripts, and computing and processing resources may be conserved when the volume of scripts is low. Thus, cloud-based and serverless execution of Python scripts in various embodiments of the present disclosure result in efficient, flexible, and elastic use of computing and processing resources, which further translates to conservation of time and real-world costs.

In various embodiments, execution of Python scripts is based at least in part on execution of container instances, or instantiations of compute containers. A compute container may be understood as a containerization or package of computer executable instructions for a given script and may include additional data required or used by the script (e.g., libraries, dependency data). Various embodiments of the present disclosure involve the use of compute containers for a variety or a set of scripts, and containerization of a variety of scripts provides various technical advantages. In particular, the use of compute containers enables flexibility and scalability, as multiple container instances of a compute container may execute substantially in parallel without excessive consumption of computing and processing resources.

In various embodiments, users initiate execution of Python scripts through an Application Program Interface (API), e.g., a RESTful API, with no knowledge of the cloud environment that executes the script. The cloud infrastructure generally has a minimum footprint when no scripts are running (e.g., zero state), and the cloud infrastructure preferably minimizes the cost of the zero state footprint. The cloud-based architecture allows script execution instances to scale, e.g., to hundreds of thousands of simultaneous executions. Script execution instances are preferably stateless. In certain embodiments, scripts are constrained to complete in a specified amount of time (which can be fixed for all scripts or negotiated/specified on a script-by-script basis) or else the script will be terminated. Embodiments generally also provide a mechanism to allow scripts to be terminated through the API also provide a mechanism to return the result of the script when completed or otherwise needed.

In certain embodiments, the system will execute multiple (e.g., two) instances of the Flex Python service (sometimes referred to herein as a “solver”) in different availability zones. Instances of the solver preferably can be spun up on demand so that there is no need to have a persistent presence running in the cloud. Once a solver instance has completed its processing, the instance can be destroyed so that costs will not be incurred when not in use.

### II. Exemplary Definitions of Certain Terms

The term “compute container” may refer to and describe a data construct that is configured to describe an instantiable package, bundle, image, and/or the like of computer executable instructions. According to various embodiments, a compute container comprises computer executable instructions for a particular Python script. That is, a compute container corresponding to a script may electronically embody and/or implement the script. A compute container may additionally include various libraries, dependency data, and/or the like required to embody and/or implement the script. Compute containers may be instantiated within a cloud-based multi-domain solver system as container instances that individually consume computing and processing resources on an on-demand basis. Compute containers may be defined using various systems, methods, architectures, and/or the like, such as Docker for example.

The term “container instance” may refer to and describe a data construct that is configured to describe an instantiation of a compute container, involving execution of computer executable instructions defined by the compute container. Multiple container instances for a compute container may execute substantially in parallel; that is, a compute container may be instantiated more than once. A container instance may execute within a cloud-based multi-domain solver system and thus use computing and processing resources on an on-demand basis. The cloud-based multi-domain solver system may include container instances of different compute containers corresponding to different Python scripts executed in parallel and/or substantially at the same time. A count of container instances of a compute container may be scaled up and/or down, which also provides technical advantages in improved management and usage of computing and processing resources within a cloud-based multi-domain solver system.

The term “serverless container management engine” may refer to a data entity configured to manage the execution of container instances of compute containers each corresponding to a Python script within a cloud-based multi-domain solver system. In doing so, the serverless container management engine may monitor execution of a container instance. In general, the serverless container management engine is configured to scale (up or down) a count of container instances based at least in part on a variety of factors. For example, the serverless container management engine may reduce the count of container instances presently and concurrently executing within the cloud-based multi-domain solver system (e.g., by halting and/or terminating some container instances) based at least in part on availability of computing and processing resources within the cloud-based multi-domain solver system, present request demand (e.g., a count of scripts posted for execution), and/or the like. Likewise, the serverless container management engine may increase the count of container instances presently and concurrently executing within the cloud-based multi-domain solver system for similar reasons. In various embodiments, the serverless container management engine is configured to generate a new container instance of a compute container, and in doing so, may be configured to access data for a compute container. In general, then, the serverless container management engine may be configured to allocate, assign, distributed, and/or the like computing and processing resources to various container instances. Example serverless container management engines that may be used in accordance with various embodiments of the present disclosure include (but are not limited to) Amazon Web Services (AWS) Fargate and Kubernetes.

The term “computing and processing resources” may generally refer to and describe the computing and processing components, such as one or more processors, memories, network interfaces, and/or the like, and portions thereof for processing and execution of computer executable instructions. For example, a processor, memory, and network interface of a cloud computing server computing entity may be computing and processing resources for executing a container instance. Usage and utilization of computing and processing resources may be measured, monitored, allocated, distributed, and/or the like for various computer executable instructions (e.g., container instances). In examples where the processor is a central processing unit (CPU), CPU time may be divided and distributed among different container instances. Likewise, resource utilization or usage may include an amount of memory reserved or used by a container instance, and monitoring such resource utilization or usage may comprise locating potential memory leaks.

The term “serverless request management engine” may refer to and describe a data entity configured to manage the receipt of script execution API requests and the transmission of script API responses within a cloud-based multi-domain solver system. A serverless request management engine may be serverless in that the receiving and processing of script execution API requests and the transmission of script API responses may consume a dynamic or variable amount of computing and processing resources. Multiple API requests may be received simultaneously and/or within a period of time at the serverless request management engine. In various embodiments, a cloud-based multi-domain solver system comprises one or more serverless request management engines each corresponding to an availability zone and configured to handle communications with a particular cohort of client computing entities, communications within a particular period of time, communications with client computing entities located in a particular area, and/or the like. Use of one or more serverless request management engines advantageously allows efficient handling of communications (e.g., receiving script execution API requests, transmitting script API responses) among a large population of client computing entities with minimal delay.

### III. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises a combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage median include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to execute certain steps or operations. Thus, embodiments of the present disclosure may also take the form of an entirely hardware embodiment, an entirely computer program product embodiment, and/or an embodiment that comprises combination of computer program products and hardware executing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be executed sequentially such that one instruction is retrieved, loaded, and executed at a time. In some exemplary embodiments, retrieval, loading, and/or execution may be executed in parallel such that multiple instructions are retrieved, loaded, and/or executed together. Thus, such embodiments can produce specifically-configured machines executing the steps or operations specified in the block diagrams and flowchart illustrations. Accordingly, the block diagrams and flowchart illustrations support various combinations of embodiments for executing the specified instructions, operations, or steps.

### IV. Exemplary Python Studio Embodiment

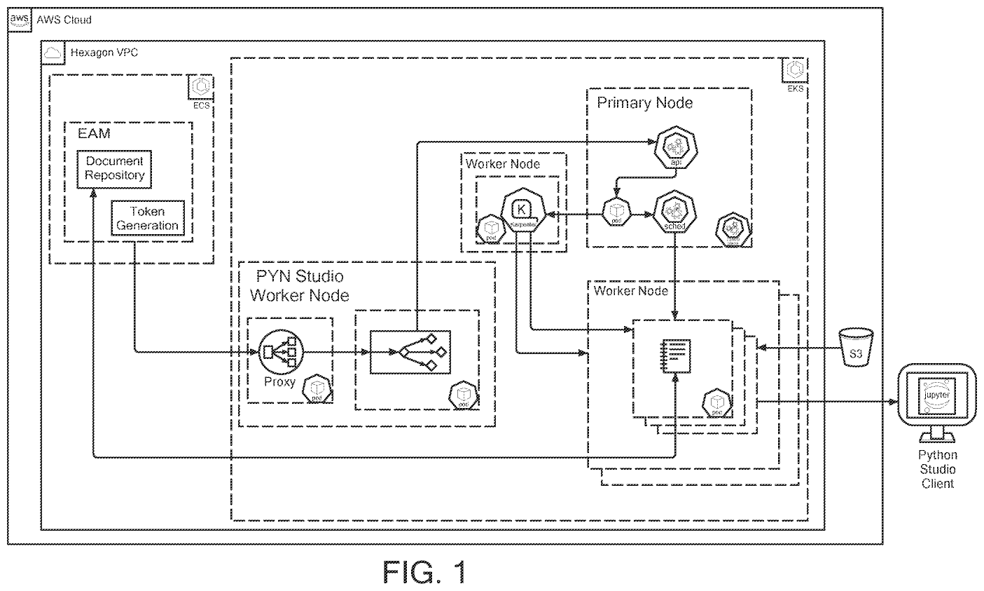

FIG. 1 is a schematic diagram of an example architecture for Python Studio in accordance with certain embodiments. Among other things, the architecture includes a primary Kubernetes node, a PYN Studio Service worker node running a PYN Studio Service instance, and a number of application worker nodes that are spun up as needed to run PYN Studio user interfaces through which users can develop and manage PYN scripts. The PYN Studio Service receives PYN Studio API requests. In this example, the PYN Studio API requests are launched directly from the host system (e.g., directly from HxGN EAM menu). Requests are sent through the Kubernetes API to a jobs queue. The control plane creates a Pod that contains a script container. In the case of the zero state where no application worker nodes have been created, Kubernetes will spin up a new worker node and assign the Pod to it for execution. In the case where an application worker node already exists and has capacity, the Kubernetes scheduler may assign the Pod to the available worker node. In this example, the script container is a container created from a containerd image that loads a Python script development application through which the user can develop and manage the script. When completed, the python script is saved or published to a document repository from which the script can managed such as to schedule execution of the script.

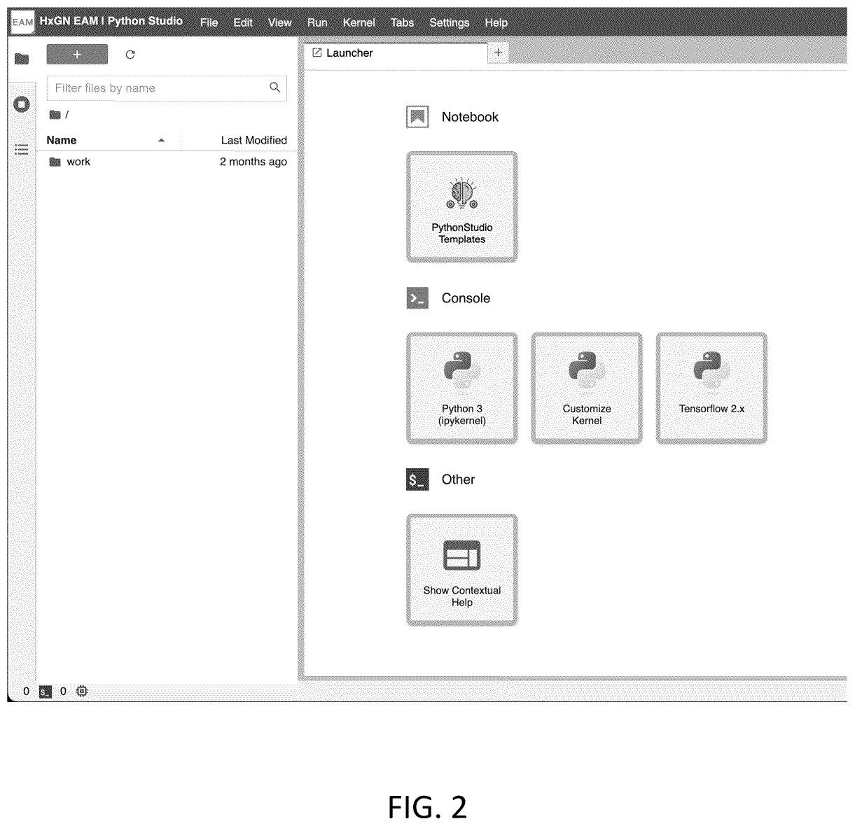

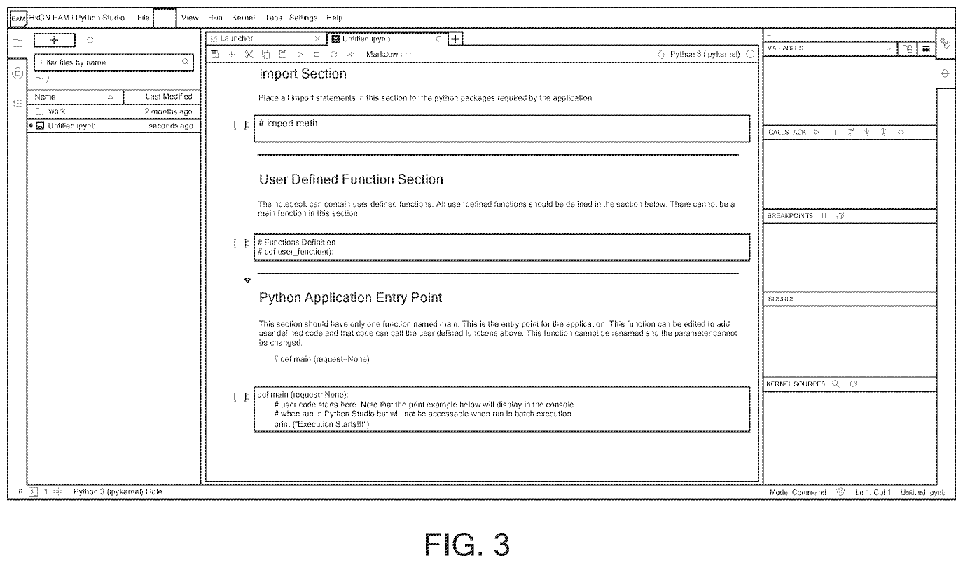

The Python script development application presents a number of user interface screens through which the user can develop and manage a script. FIG. 2 is a schematic diagram showing a Python Studio home screen in accordance with certain embodiments. This screen (or one like it) is generally displayed when a PYN Studio is launched. From this screen, the user can create a new script or continue working on an existing script. FIG. 3 is a schematic diagram showing a Python Studio screen through which the user can develop the script section-by-section, thereby facilitating the development of the script.

Among other things, allowing the Python Studio to be launched direction from the host application and also allowing scripts to be executed from the host system as discussed below (e.g., user-initiated or automatically-initiated such as in an event-driven manner) adds significant power and flexibility to the host system. Also, the Python Studio provides extensibility for writing, managing, and executing Python scripts that can include anything from simple python scripts to complex machine learning algorithms (e.g., TensorFlow) including the ability for scripts to include or run other scripts. Python Studio can leverage public domain or commercially available scripting tools (e.g., JupyterLab).

### V. Exemplary Flex Python System Framework

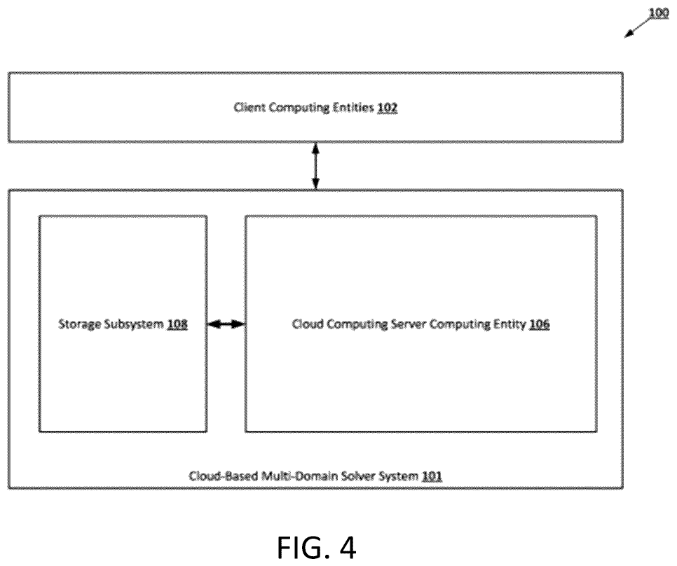

FIG. 4 is a schematic diagram of an example architecture 100 for Flex Python in accordance with certain embodiments. The architecture 100 includes a cloud-based multi-domain solver system 101 configured to receive script execution API requests, manage execution of container instances of compute containers corresponding to scripts, and provide script outputs. In various embodiments, the cloud-based multi-domain solver system 101 scales a count of container instances undergoing execution based at least in part on various factors, including availability of computing and processing resources and a number of script execution API requests received. For example, the cloud-based multi-domain solver system 101 may assign, increase, allocate, and/or the like computing and processing resources to a container instance in execution and/or may restrict, reduce, cut off, and/or the like computing and processing resources to a container instance in execution.

In various embodiments, the cloud-based multi-domain solver system 101 communicates with a plurality of client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like). The cloud-based multi-domain solver system 101 may receive script execution API requests originating from various client computing entities 102 via such communication networks and may further transmit script API responses to various client computing entities 102 via such communication networks.

The cloud-based multi-domain solver system 101 may include a cloud computing server computing entity 106 and a storage subsystem 108. The cloud computing server computing entity 106 may be configured for serverless execution of container instances for determining solutions to input problems. That is, execution of a container instance may be accomplished using a variable amount of computing and processing resources of the cloud computing server computing entity 106. In this regard, the cloud computing server computing entity 106 may be understood as an abstraction of one or more individual computing entities sharing computing and processing resources. The cloud computing server computing entity 106 may be configured to receive and process script execution API requests. In various embodiments, the cloud computing server computing entity 106 generates and terminates container instances (e.g., by supplying and/or by removing computing and processing resources from container instances), executes scripts, and provides script API responses.

The storage subsystem 108 may be configured to store data used by the cloud computing server computing entity 106 in a containerized, cloud-based manner. For example, the storage subsystem 108 may be configured to store compute containers each corresponding to a script and configured to be instantiated and executed as container instances. The storage subsystem 108 may be further configured to store an inbound problem queue and an outbound solution queue for scheduling and communication management if needed. The storage subsystem 108 may include one or more storage units, such as multiple distributed storage units that are connected through a computer network (e.g., an internal communication network of the cloud-based multi-domain solver system 101). Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Cloud Computing Server Computing Entity

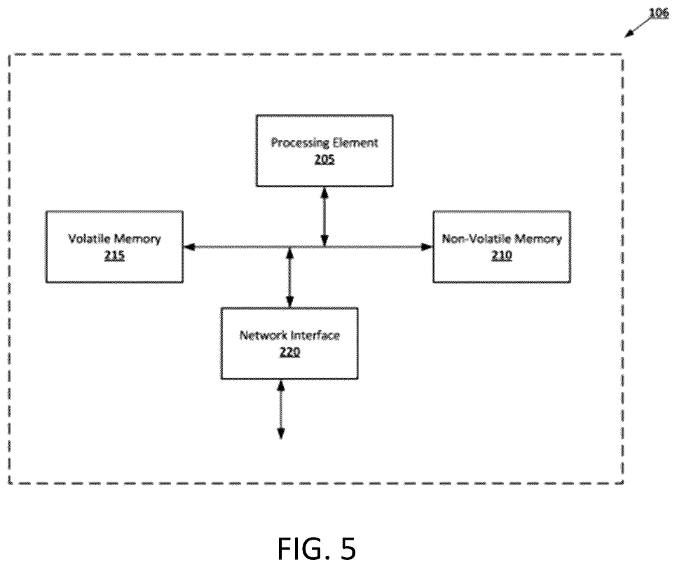

FIG. 5 provides a schematic of a cloud computing server computing entity 106 according to one embodiment of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to execute the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be executed on data, content, information, and/or similar terms used herein interchangeably.

As indicated, in one embodiment, the cloud computing server computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. The cloud computing server computing entity 106 may communicate with a plurality of client computing entities 102 via the one or more communications interfaces 220, such as to receive script execution API requests and to transmit script API responses.

As shown in FIG. 5, in one embodiment, a cloud computing server computing entity 106 may include, or be in communication with, one or more processing elements 205 (also referred to as processors, processing circuitry, and/or similar terms used herein interchangeably) that communicate with other elements within the cloud computing server computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of executing steps or operations according to embodiments of the present disclosure when configured accordingly.

In one embodiment, the cloud computing server computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity—relationship model, object model, document model, semantic model, graph model, and/or the like.

In one embodiment, the cloud computing server computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the cloud computing server computing entity 106 with the assistance of the processing element 205 and operating system.

As indicated, in one embodiment, the cloud computing server computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the cloud computing server computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the cloud computing server computing entity 106 may include, or be in communication with, one or more input elements, such as a keyboard input, a mouse input, a touch screen/display input, motion input, movement input, audio input, pointing device input, joystick input, keypad input, and/or the like. The cloud computing server computing entity 106 may also include, or be in communication with, one or more output elements (not shown), such as audio output, video output, screen/display output, motion output, movement output, and/or the like.

### Exemplary Client Computing Entity

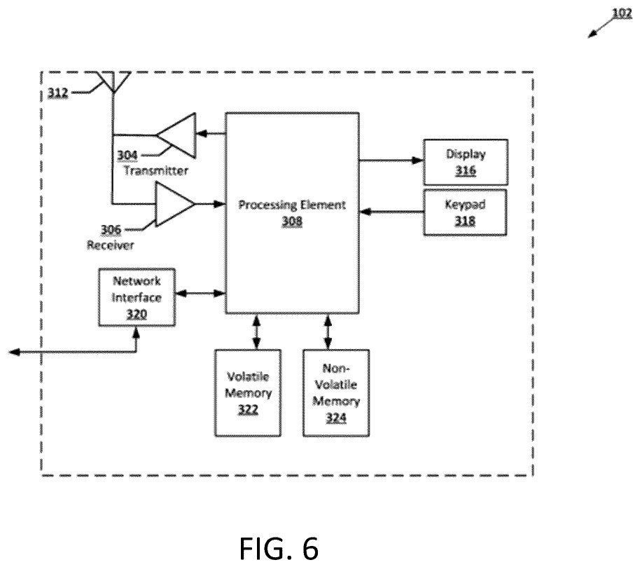

FIG. 6 provides an illustrative schematic representative of a client computing entity 102 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the cloud computing server computing entity 106. In a particular embodiment, the client computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the cloud computing server computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the cloud computing server computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the cloud computing server computing entity 106 and/or various other computing entities.

In another embodiment, the client computing entity 102 may include one or more components or functionality that are the same or similar to those of the cloud computing server computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### VI. Exemplary Flex Python System Operations

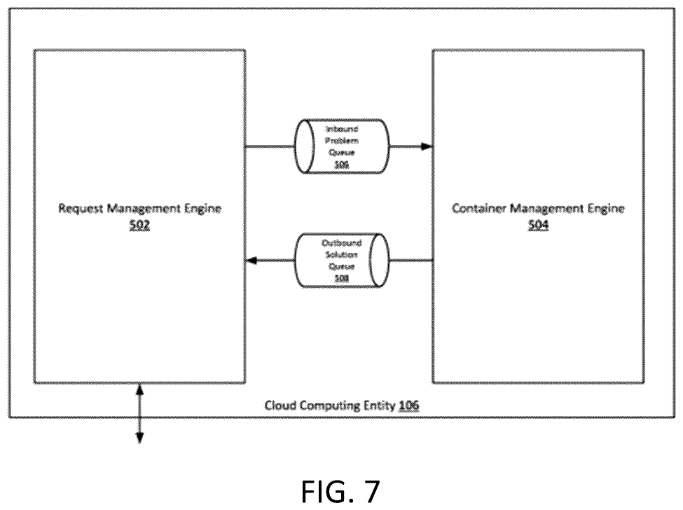

In various embodiments, the cloud-based multi-domain solver system 101 comprises a request management engine in communication with and/or comprising the type-agnostic problem API. FIG. 7 illustrates an example block diagram of a cloud computing server computing entity 106 comprising a request management engine 502. The request management engine 502 is configured to receive, process, handle, and/or the like script execution API requests originating from various client computing entities 102.

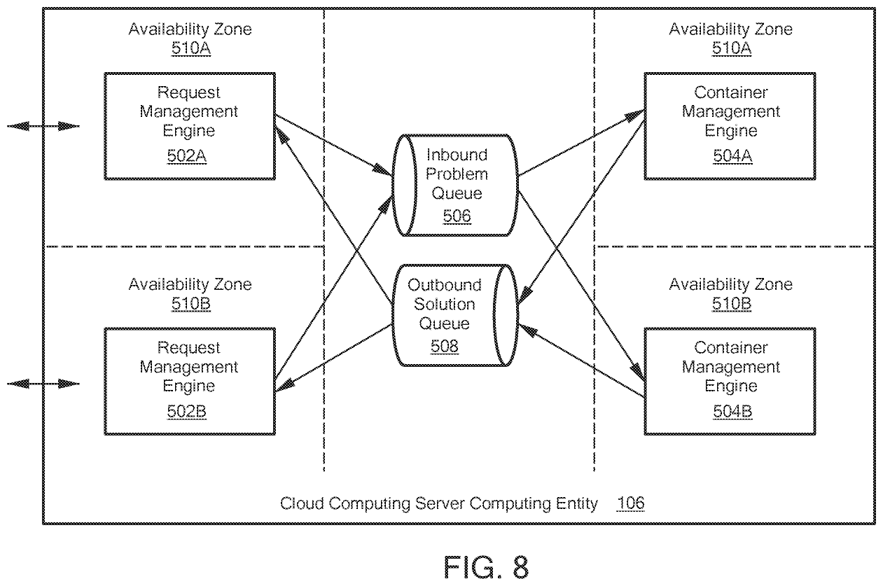

In various embodiments, the cloud computing server computing entity 106 comprises one or more request management engines 502, each configured to receive and process script execution API requests originating from various client computing entities 102, such as is illustrated in FIG. 8. In such embodiments, each request management engine 502 may correspond to an availability zone 510A-B. An availability zone 510A-B describes a range of responsibility of a corresponding request management engine 502. For example, a first request management engine 502A corresponding to a first availability zone 510A may be configured to receive and process script execution API requests originating from a first cohort of client computing entities 102, while a second request management engine 502B corresponding to a second availability zone 510B may be configured to receive and process script execution API requests originating from a second cohort of client computing entities 102. As another example, use of request management engines 502 of different availability zones 510A-B may be based at least in part on demand, wherein the second request management engine 502B corresponding to the second availability zone 510B is configured to receive and process script execution API requests when the first request management engine 502A corresponding to the first availability zone 510A is consuming a threshold amount of computing and processing resources when receiving and processing script execution API requests. Accordingly, the use of more than one request management engine 502 and the division of the same among different availability zones 510A-B advantageously provides efficient and flexible use of computing and processing resources.

In various embodiments, the request management engine(s) 502 may communication with an inbound problem queue 506. In various instances, multiple script execution API requests may be received by the request management engine 502. In various embodiments, script execution requests may be organized within the inbound problem queue 506, such as in a first-in-first-out (FIFO) manner.

Compute containers are instantiated within the cloud-based multi-domain solver system 101 as container instances that individually consume computing and processing resources on an on-demand basis. That is, a container instance is defined as an instantiation of a compute container. Upon generation of a container instance, the container instance may be configured to begin execution automatically and in a standalone manner. Execution of a container instance consumes some amount of computing and processing resources, and such resources may be appropriately allocated and distributed between one or more container instances. A minimum amount of computing and processing resources required to execute a container instance of a particular compute container may be a defined and described parameter of the particular compute container, in various embodiments, and a container instance may be generated when at least the minimum amount of computing and processing resources required for execution is available.

Generation and execution of container instances may be managed by one or more container management engines 504 of the cloud computing server computing entity 106, illustrated in FIG. 7 and FIG. 8. In various embodiments, a container management engine 504 is configured to generate a container instance of a compute container and dynamically allocate an amount of computing and processing resources to execution of the container instance. As part of dynamic allocation of computing and processing resources among one or more container instances, a container management engine 504 is configured to monitor usage and distribution of the computing and processing resources of the cloud computing server computing entity 106 and re-distribute such resources among the container instances when deemed necessary. Similarly, a container management engine 504 is configured to monitor an available amount of computing and processing resources and generate a container instance if the available amount of computing and processing resources satisfies the minimum amount of computing and processing resources required for execution of the container instance. In various embodiments, a container management engine 504 also does not allocate an excess amount of computing and processing resources to a container instance, and the amount of computing and processing resources allocated to a container instance may be limited by one or more configurable thresholds or limits. Various further variations of container instantiation will come to mind of one skilled in the field to which the present disclosure pertains. For instance, container instances for the one or more compute containers are generated dynamically over time.

As shown in FIG. 8, the cloud computing server computing entity 106 may comprise one or more container management engines 504 each corresponding to an availability zone 510 and each configured to manage the generation and execution of container instances for script requests received in the corresponding availability zone 510. Further, computing and processing resources of the cloud computing server computing entity 106 may be divided or partitioned between multiple availability zones 510, and a container management engine 504 is configured to allocate computing and processing resources for a corresponding availability zone 510 to the generation and execution of container instances. In the illustrated embodiment, the cloud computing server computing entity 106 comprises a first container management engine 504A corresponding to a first availability zone 510A and a second container management engine 504B corresponding to a second availability zone 510B.

The one or more container instances may be generated (e.g., via a container management engine 504) based at least in part on the inbound problem queue 506. Specifically, the inbound problem queue 506 may indicate that a particular script is ready to be executed and may communicate with a container management engine 504 to generate container instances for one or more compute containers each corresponding to a selected script. In communicating with the inbound problem queue 506, a container management engine 504 may receive or retrieve a script, including various parameters, values, and data relevant to the input problem, and may provide the script to a container instance upon generation. Accordingly, the container instance, once generated, is equipped to execute a script.

As previously described, a container instance may be configured to automatically begin execution upon generation. In various embodiments, a container instance may comprise a heartbeat API that is used to indicate that a script is presently being executed using the container instance (e.g., the container instance is “alive”). In various embodiments, a container instance communicates with a container management engine 504 and/or the inbound problem queue 506 via the heartbeat API, informing the container management engine 504 and/or the inbound problem queue 506 that the container instance is “alive” and executing. During the execution of at least one container instance for a particular input problem, the status associated with the particular script at the inbound problem queue 506 may be configured to a “processing”, “handling”, and/or the like status.

In various embodiments, monitoring the execution of a container instance comprises monitoring the amount of computing and processing resources allocated to the container instance and/or consumed by the container instance. In monitoring resource usage and utilization of a container instance, usage data associated with multiple timepoint may be collected and analyzed. In various embodiments, usage data comprises dedicated processing time (e.g., a fraction of total time spent by one or more processors to process the container instance), memory size (e.g., amount of memory storage, volatile and/or non-volatile, reserved and used by the container instance), and/or the like.

In some embodiments, halting of execution of a container instance may be caused via the heartbeat API of the container instance. For example, the container instance may receive a halt, kill, terminate, and/or the like command originating from a container management engine 504 via the heartbeat API. In some embodiments, a container instance is configured to automatically halt execution responsive to one or more unsatisfactory per-iteration optimization gains and may transmit a final heartbeat message indicating halting of execution via the heartbeat API. In various embodiments, a container instance may be halted, paused, killed, terminated, and/or the like by limiting or stopping computing and processing resources from being allocated for the container instance. Computing and processing resources may be actively deallocated (e.g., by a container management engine 504) from the container instance to other container instances. Additionally or alternatively, halting of execution of a container instance may be based on a timeout value associated with the script, e.g., if the script does not complete within the specified timeout value.

Generation of the script output may comprise updating the outbound solution queue 508, illustrated in FIG. 7 and FIG. 8. As multiple input problems may be received with a time period, the outbound solution queue 508 may be configured to identify (e.g., store) more than one script output. The outbound solution queue 508 may also store a status associated with each script output, and a script output may be added to the outbound solution queue 508 with a “ready to return”, “ready to transmit”, and/or the like status. Meanwhile, addition of a script output to the outbound solution queue 508 may comprise updating the inbound problem queue 506. For example, the script in the inbound problem queue 506 may be updated to a “finished” status and/or be removed from the inbound problem queue 506.

Generation of the script output may further comprise scaling down container instances. As the script output is generated, execution of container instances is no longer needed, and such container instances may be halted, paused, and/or terminated. In some embodiments, some container instances may be redirected to other scripts identified by the inbound problem queue 506 and may accordingly receive and/or retrieve script features from the inbound problem queue 506. In some instances, however, another script may be unavailable and container instances may be terminated. Accordingly, the count of container instances in execution is flexible and based at least in part on the volume of scripts in the inbound problem queue 506.

In various embodiments, the script output may be provided to the client computing entity 102 via a request management engine 502. The script output may be specifically provided via the request management engine 502 corresponding to the availability zone 510A-B at which the script execution API request was received. In providing the script output, the request management engine 502 may be configured to communicate with the outbound solution queue 508 (e.g., receive or retrieve at least the script output from the outbound solution queue 508). After providing the script output, the outbound solution queue 508 may be updated, and specifically, the script output in the outbound solution queue 508 may be deleted.

Accordingly, various steps, operations, methods, processes, and/or the like are described herein for executing Python scripts in a containerized, cloud-based (e.g., serverless) manner. In an example embodiment, a script execution API request is received originating from a client computing entity 102. The script execution API request is processed, and a corresponding input is added to the inbound problem queue 506 (e.g., by a request management engine 502). A container management engine 504 is informed of the script via the inbound problem queue 506 and generates one or more container instances each associated with a script (e.g., by the request management engine 502). Execution of the one or more container instances results in generation of a one or more script outputs. The script output is added to the outbound solution queue 508, while the input script is removed from the inbound problem queue 506. The script output is then provided to the client computing entity 102 via a script API response (e.g., via the request management engine 502).

Various embodiments described herein provide various technical advantages by enabling flexible and elastic determination of optimized solutions for a volume of scripts to be executed. In various example instances, computing and processing resources may be diverted, allocated, reserved, and/or the like, and computing and processing resources may be conserved when the volume of scripts is low. Thus, cloud-based and serverless script execution in various embodiments of the present disclosure result in efficient, flexible, and elastic use of computing and processing resources, which further translates to conservation of time and real-world costs. Further, the use of compute containers for a variety of scripts enable flexibility and scalability, as multiple container instances of a compute container may execute substantially in parallel without excessive consumption of computing and processing resources.

### VII. Exemplary Flex Python Implementation

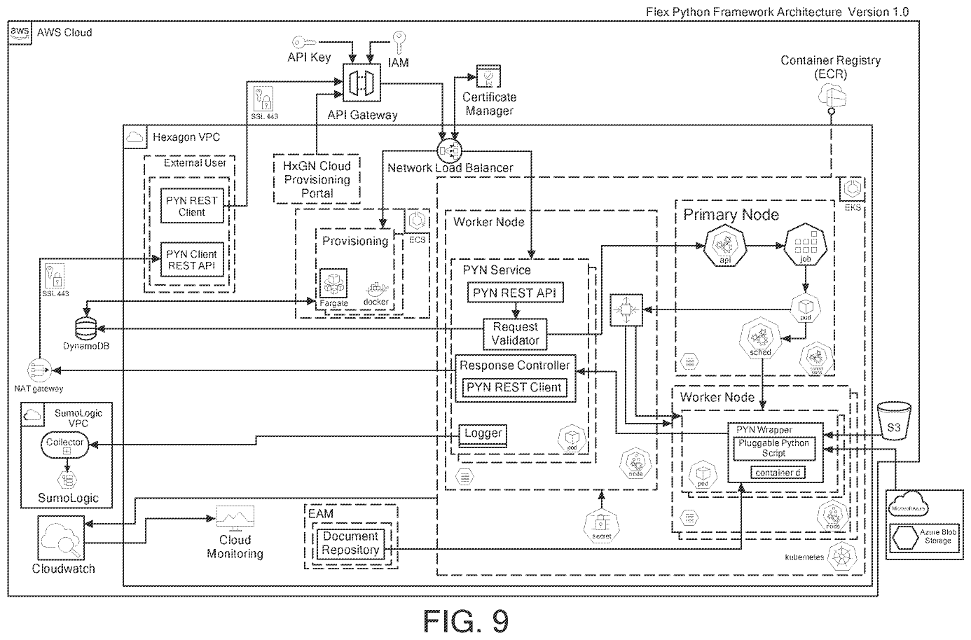

FIG. 9 is a schematic diagram showing details of a cloud-based multi-domain solver system 101 in accordance with various embodiments. Among other things, the cloud-based multi-domain solver system 101 includes a provisioning API, a primary Kubernetes node, at least one (and preferably two or more) PYN Service worker nodes each running a PYN Service instance, and a number of application worker nodes that are spun up as needed to run Python scripts.

The provisioning API validates clients of the system. Specifically, the first time the system receives a specific customer ID, the customer ID is validated via the Provisioning API and is persisted in a database, and then every time a solve request transaction is received from that client, the system can confirm that the client is valid and able to use the solver service.

The PYN Service receives script execution API requests from various users via a multi-domain Representational State Transfer (REST) API that preferably is configured to allow multiple different domain-specific client computing entities to be added to and removed from the system in a plug-and-play fashion, e.g., as support for new domains is added to the system. Users can include external users and/or internal users (e.g., the host system such as an EAM system or other entity). Requests are validated, then sent through the Kubernetes API to a jobs queue. The control plane creates a Pod that contains an application container. In the case of the zero state where no application worker nodes have been created, Kubernetes will spin up a new worker node and assign the Pod to it for execution. In the case where an application worker node already exists and has capacity, the Kubernetes scheduler may assign the Pod to the available worker node. The application is a container created from a containerd image that loads the user's python zip for execution. The python zip contains the .py file and a requirements.txt file listing any dependent packages. The python executable script can be accessed, e.g., from AWS S3, Azure Blob, or EAM Document Repository. The python script executes in a manner that is isolated from other Pods. When the python script completes, any output is sent to the Response Controller of the PYN Service worker node, which sends an asynchronous acknowledgement to the calling application. In certain embodiments, the Kubernetes nodes running on EC2 instances are protected with Crowdstrike Falcon to stop breaches via a unified set of cloud-delivered technologies that prevent all types of attacks including malware.

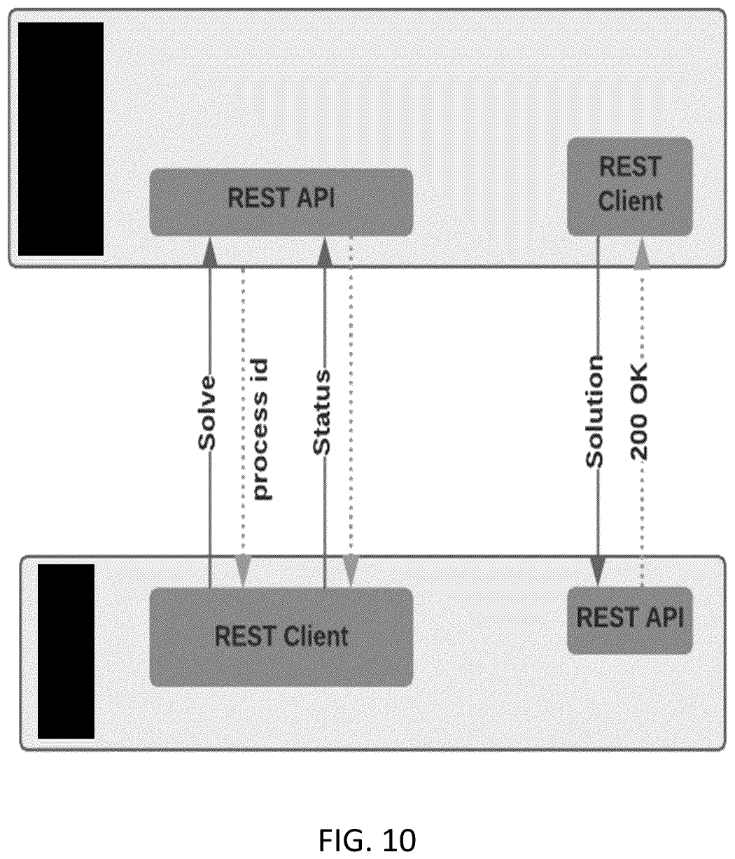

FIG. 10 is a schematic diagram showing details of the REST API in accordance with the embodiment of FIG. 9. Different domain-specific client computing entities can utilize different parameters, and the REST API allows such domain-specific client computing entities to utilize this common API by transferring domain-specific information to the PYN Solver at the time of making a request in a stateless manner, e.g., using JSON or other appropriate representation format. Among other things, the REST API provides an extensible API that allows new functionality to be added without breaking backward compatibility. It uses JSON, a lightweight data-interchange format that is easy for humans to read and write and easy for machines to parse and generate. The API is based on the Open API specification. The REST API is associated with different specifications and properties for different domains, which allows clients to use only the API with the domain that they need and allows the solver system to send responses to the clients with domain-specific information.

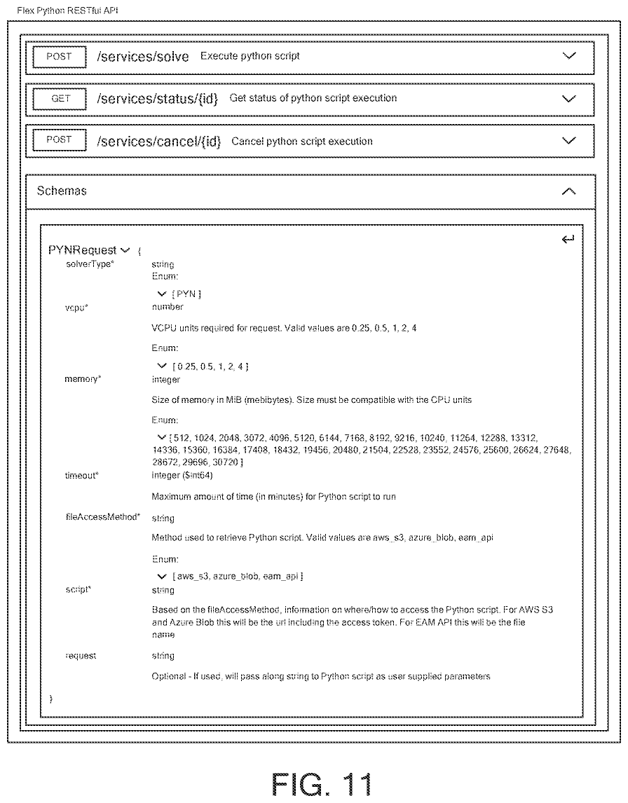

As shown schematically in FIG. 11, the REST API includes three primitives, namely a POST/services/solve primitive to initiate execution of a script, a GET/services/status/{id} primitive to request the execution status of the identified script, and a POST/services/cancel/{id} primitive to terminate execution of the identified script. In certain exemplary embodiments, the POST/services/solve primitive must specify a CPU size, an amount of memory, and a timeout value. In certain embodiments, the POST/services/solve primitive specified the number of virtual CPU units required for the request, the amount of memory required for the request, a timeout value indicating the maximum amount of time for the Python script to run, a file access method indicating the method used to retrieve the Python script (e.g., a URL, a host system API, etc.), optionally information on where/how to access the Python script depending on the file access method (e.g., a URL, a file name, etc.), and optionally user-supplied parameters. The Python script can be retrieved by the primary node, by the Python service instance that handled the requests, or by the worker node that is executing the Python script.

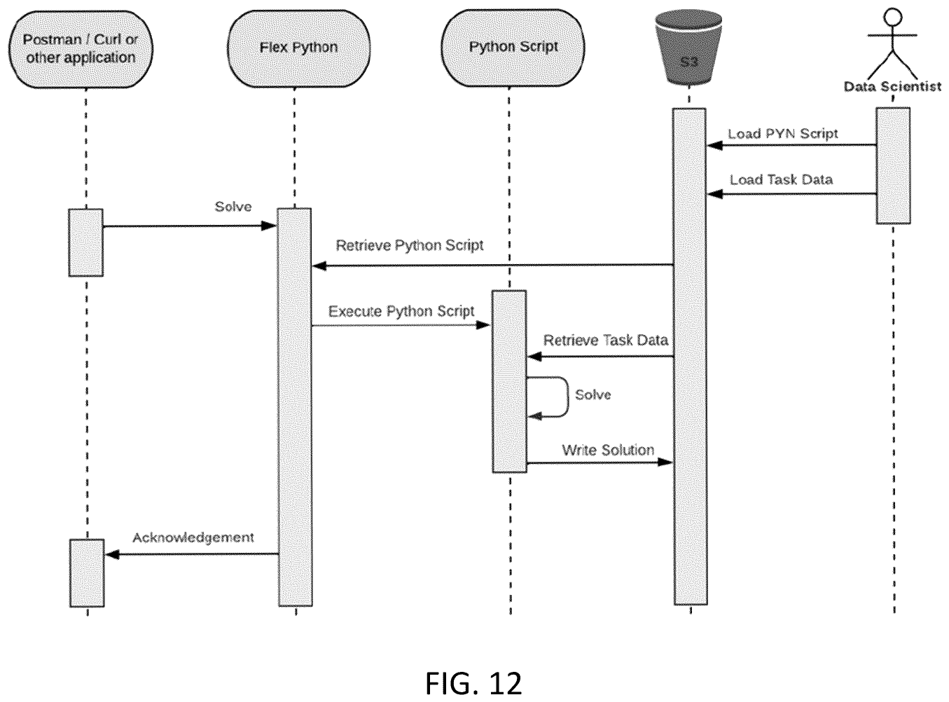

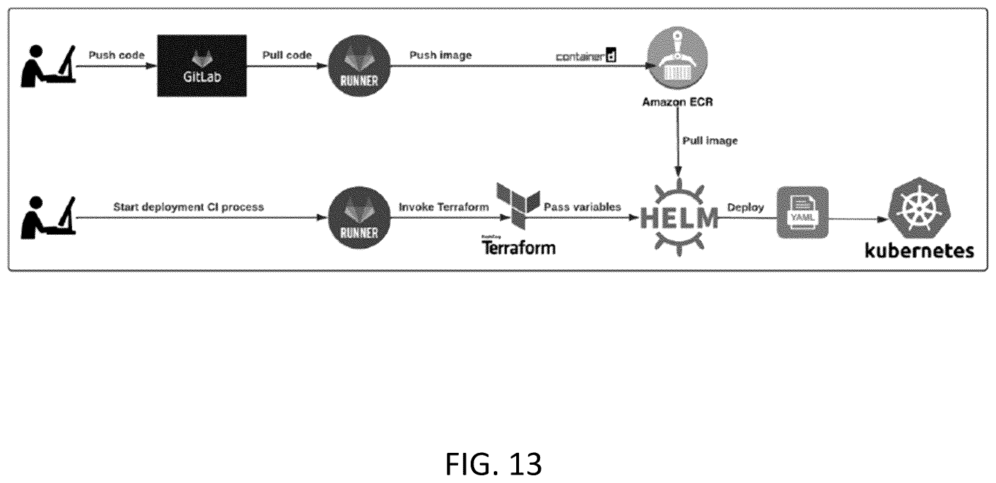

FIGS. 12 and 13 schematically show the progression of a script execution transaction in accordance with certain embodiments. The client (e.g., plug-in) sends a solve request to Flex Python via the REST API, which validates the client, and assuming the client is validated, validates the request and pushes the request to the primary node. The script is executed as discussed above. Throughout this process, the primary node updates status information, e.g., to indicate when the solver is processing the request and when the solver has finished the request. The response service pulls the solution from the outbound queue and sends the solution to the client via the call back API.

As discussed above, script execution can be launched in various ways, e.g., user-initiated, event triggered (e.g., through FlexSQL configuration), and/or integrated with an alerts module (e.g., EAM Alerts). Thus, for example, in certain embodiments, the host system can be configured to launch execution of one or more scripts based on an event or alert in the system. Without limitation, the event can be based on time (e.g., execute script A every 15 minutes), an internal event in the host system (e.g., launch execution of a script every time someone tries to log on as a particular user), an external event (e.g., monitoring an online source and launching execution of a script based on the online source), etc.

### VIII. Potential Claims

Various embodiments of the present invention may be characterized by the potential claims listed in the paragraphs following this paragraph (and before the actual claims provided at the end of the application). These potential claims form a part of the written description of the application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public. Nor are these potential claims intended to limit various pursued claims. Without limitation, potential subject matter that may be claimed (prefaced with the letter “P” so as to avoid confusion with the actual claims presented below) includes:

P1. A computer-implemented method for developing and executing Python scripts, the method comprising: providing, from a host computer system, a Python development user interface through which a user develops a Python script, wherein the Python development user interface runs on a first cloud-based worker node that is dynamically allocated for the Python development user interface; transmitting the Python script from the first cloud-based worker node to the host computer system; storing the Python script in a storage of the host computer system; triggering, from the host computer system, via a REST API, execution of the Python script in a second cloud-based worker node that is dynamically allocated for execution of the Python script; and upon completion of execution of the Python script, asynchronously sending a Python script output to the host computer system via the REST API.

P2. The computer-implemented method of claim P1, wherein the host computer system is an Enterprise Asset Management system.

P3. The computer-implemented method of claim P1, wherein execution of the Python script is associated with a timeout value, and wherein execution of the Python script is terminated when execution of the Python script has not completed within the timeout value.

P4. The computer-implemented method of claim P1, wherein triggering execution of the Python script via the REST API comprises generating a POST solve primitive via the REST API, and wherein the POST solve primitive is received at a serverless request management engine native to a server cloud infrastructure and corresponding to one of one or more availability zones.

P5. The computer-implemented method of claim P1, wherein dynamic allocation of the second cloud-based worker node is managed by a serverless container management engine that is native to a server cloud infrastructure.

P6. The computer-implemented method of claim P5, wherein the serverless container management engine is configured to scale a total count of container instances based at least in part on a total count of the Python scripts requested for execution.

P7. The computer-implemented method of claim P1, wherein execution of the Python script is triggered automatically by the host computer system in accordance with a predetermined trigger parameter.

P8. A system for developing and executing Python scripts, the system comprising (1) a host computer system configured to provide a Python development user interface through which a user develops a Python script, wherein the Python development user interface runs on a first cloud-based worker node that is dynamically allocated for the Python development user interface; receive the Python script from the first cloud-based node; store the Python script in a storage of the host computer system; trigger, via a REST API, execution of the Python script in a second cloud-based worker node that is dynamically allocated for execution of the Python script; and receive a Python script output via the REST API; and (2) a cloud computing system configured to run the Python development user interface on the first cloud-based worker node that is dynamically allocated for the Python development user interface; transmit the Python script from the first cloud-based worker node to the host computer system; execute the Python script in a second cloud-based worker node that is dynamically allocated for execution of the Python script; and upon completion of execution of the Python script, asynchronously sending a Python script output to the host computer system via the REST API.

P9. The system of claim P8, wherein the host computer system is an Enterprise Asset Management system.

P10. The system of claim P8, wherein execution of the Python script is associated with a timeout value, and wherein execution of the Python script is terminated when execution of the Python script has not completed within the timeout value.

P11. The system of claim P8, wherein triggering execution of the Python script via the REST API comprises generating a POST solve primitive via the REST API, and wherein the POST solve primitive is received at a serverless request management engine native to a server cloud infrastructure and corresponding to one of one or more availability zones.

P12. The system of claim P8, wherein dynamic allocation of the second cloud-based worker node is managed by a serverless container management engine that is native to a server cloud infrastructure.

P13. The system of claim P12, wherein the serverless container management engine is configured to scale a total count of container instances based at least in part on a total count of the Python scripts requested for execution.

P14. The system of claim P8, wherein execution of the Python script is triggered automatically by the host computer system in accordance with a predetermined trigger parameter.

P15. A computer program product comprising at least one non-transitory computer-readable storage medium having computer-readable program code portions stored therein which, when executed on one or more processors, cause the one or more processors to implement (1) a host computer system configured to provide a Python development user interface through which a user develops a Python script, wherein the Python development user interface runs on a first cloud-based worker node that is dynamically allocated for the Python development user interface; receive the Python script from the first cloud-based node; store the Python script in a storage of the host computer system; trigger, via a REST API, execution of the Python script in a second cloud-based worker node that is dynamically allocated for execution of the Python script; and receive a Python script output via the REST API; and (2) a cloud computing system configured to run the Python development user interface on the first cloud-based worker node that is dynamically allocated for the Python development user interface; transmit the Python script from the first cloud-based worker node to the host computer system; execute the Python script in a second cloud-based worker node that is dynamically allocated for execution of the Python script; and upon completion of execution of the Python script, asynchronously sending a Python script output to the host computer system via the REST API.

P16. The computer-implemented method of claim P15, wherein the host computer system is an Enterprise Asset Management system.

P17. The computer-implemented method of claim P15, wherein execution of the Python script is associated with a timeout value, and wherein execution of the Python script is terminated when execution of the Python script has not completed within the timeout value.

P18. The computer-implemented method of claim P15, wherein triggering execution of the Python script via the REST API comprises generating a POST solve primitive via the REST API, and wherein the POST solve primitive is received at a serverless request management engine native to a server cloud infrastructure and corresponding to one of one or more availability zones.

P19. The computer-implemented method of claim P15, wherein dynamic allocation of the second cloud-based worker node is managed by a serverless container management engine that is native to a server cloud infrastructure.

P20. The computer-implemented method of claim P19, wherein the serverless container management engine is configured to scale a total count of container instances based at least in part on a total count of the Python scripts requested for execution.

P21. The computer-implemented method of claim P15, wherein execution of the Python script is triggered automatically by the host computer system in accordance with a predetermined trigger parameter.

### IX. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A system for execution of Python scripts in a containerized, cloud-based, multi-tenant manner, the system comprising:
a primary service node executing in a cloud computing system, the primary service node comprising a pod generator and a scheduler; and
at least one worker service node executing in the cloud computing system, each worker service node executing a Python service instance comprising a Python service application program interface (API), a request validator, and a response controller, wherein:
each Python service instance is configured to receive a Python script execution request from a client via the Python service API, validate the request by the request validator, communicate the request to the primary service node, receive an output from execution of the Python script by the response controller, and asynchronously communicate the output to the client by the response controller; and
the primary service node is configured to generate a pod containing an application container for the Python script and assign the pod to an application worker node for execution including, when there is no existing application worker node for the pod, dynamically allocating a new application worker node and assigning the pod to the new application worker node.

2. The system of claim 1, wherein the Python service API is a Representational State Transfer (REST) API.

3. The system of claim 1, wherein the Python script execution request includes a timeout value, and wherein the application worker node executing the Python script terminates execution of the Python script if execution is not completed within the timeout value.

4. The system of claim 1, wherein the Python script execution request includes parameters for retrieval of the Python script.

5. The system of claim 4, wherein the application container retrieves the Python script based on the parameters.

6. The system of claim 4, wherein the parameters include a URL.

7. The system of claim 4, wherein the parameters include a file name.

8. A computer-implemented method for execution of Python scripts in a containerized, cloud-based, multi-tenant manner, the method comprising:
executing a primary service node in a cloud computing system, the primary service node comprising a pod generator and a scheduler; and
executing at least one worker service node in the cloud computing system, each worker service node executing a Python service instance comprising a Python service application program interface (API), a request validator, and a response controller, wherein:
each Python service instance is configured to receive a Python script execution request from a client via the Python service API, validate the request by the request validator, communicate the request to the primary service node, receive an output from execution of the Python script by the response controller, and asynchronously communicate the output to the client by the response controller; and
the primary service node is configured to generate a pod containing an application container for the Python script and assign the pod to an application worker node for execution including, when there is no existing application worker node for the pod, dynamically allocating a new application worker node and assigning the pod to the new application worker node.

9. The method of claim 8, wherein the Python service API is a Representational State Transfer (REST) API.

10. The method of claim 8, wherein the Python script execution request includes a timeout value, and wherein the application worker node executing the Python script terminates execution of the Python script if execution is not completed within the timeout value.

11. The method of claim 8, wherein the Python script execution request includes parameters for retrieval of the Python script.

12. The method of claim 11, wherein the application container retrieves the Python script based on the parameters.

13. The method of claim 11, wherein the parameters include a URL.

14. The method of claim 11, wherein the parameters include a file name.

15. A computer program product comprising at least one non-transitory computer-readable storage medium having computer-readable program code portions stored therein which, when executed on one or more processors, cause the one or more processors to implement:
a primary service node executing in a cloud computing system, the primary service node comprising a pod generator and a scheduler; and
at least one worker service node executing in the cloud computing system, each worker service node executing a Python service instance comprising a Python service application program interface (API), a request validator, and a response controller, wherein:
each Python service instance is configured to receive a Python script execution request from a client via the Python service API, validate the request by the request validator, communicate the request to the primary service node, receive an output from execution of the Python script by the response controller, and asynchronously communicate the output to the client by the response controller; and
the primary service node is configured to generate a pod containing an application container for the Python script and assign the pod to an application worker node for execution including, when there is no existing application worker node for the pod, dynamically allocating a new application worker node and assigning the pod to the new application worker node.

16. The computer program product of claim 15, wherein the Python service API is a Representational State Transfer (REST) API.

17. The computer program product of claim 15, wherein the Python script execution request includes a timeout value, and wherein the application worker node executing the Python script terminates execution of the Python script if execution is not completed within the timeout value.

18. The computer program product of claim 15, wherein the Python script execution request includes parameters for retrieval of the Python script.

19. The computer program product of claim 18, wherein the application container retrieves the Python script based on the parameters.

20. The computer program product of claim 18, wherein the parameters include a URL.

21. The computer program product of claim 18, wherein the parameters include a file name.
